(19) United States
(12) Patent Application Publication
(10) Pub. No.: US 2002/0118416 A1
(43) Pub. Date: Aug. 29, 2002

(54) Method of setting up a connection in at least one optical WDM transmission system

(76) Inventor: Bernd Stilling, Muenchen (DE)

Correspondence Address: BELL, BOYD & LLOYD, LLC, P. O. BOX 1135, CHICAGO, IL, 60690-1135, US

(21) Appl. No.: 10/072,057

(22) Filed: Feb. 8, 2002

(30) Foreign Application Priority Data
Feb. 8, 2001 (DE) 101 056 75.3

(51) Int. Cl. G02B 6/28; G02B 6/293; H04J 14/02

(52) U.S. Cl. 359/124; 385/24

(57) ABSTRACT

A method of setting up a connection in a WDM transmission system with a number of switchable optical network nodes, of which at least one has a wavelength converter, wherein for setting up a connection from a first optical network node over at least one connection path section to an Nth optical network node, a first connection vector is formed for identifying WDM transmission channels available on the following connection path section and is transmitted over the at least one optical WDM transmission system and, in the at least one optical network node having a wavelength converter, a further connection vector is formed for identifying available WDM transmission channels on the following connection path section and is transmitted over the at least one optical WDM transmission system.

### BACKGROUND OF THE INVENTION

The present invention relates to a method of setting up a connection in an optical WDM transmission system with a number of switchable optical network nodes, of which at least one has a wavelength converter, in which, for setting up a connection from a first optical network node over at least one connection path section to an Nth optical network node, a first connection vector is formed for identifying WDM transmission channels available on the following connection path section and is transmitted over the at least one optical WDM transmission system.

In optical transmission systems, in particular wavelength-division-multiplexing (WDM) long-distance transmission systems, optical transmission signals or optical WDM signals are transmitted at different data rates and/or wavelengths. To achieve high transmission capacities, the optical WDM signals are transmitted in individual WDM transmission channels. For this purpose, optical transport networks or WDM transmission systems have series-connected optical “cross connectors”, or optical network nodes, which are connected to one another via point-to-point connections. In this way, optical connections via a number of optical cross connects or optical network nodes are set up, maintained or cleared down. However, the operators of such optical transport networks or WDM transmission systems would like an increase in flexibility with regard to the adaptation of such optical networks to dynamically changing traffic volumes. For this purpose, transparent optical switching matrices, which make it possible for the optical data streams to be flexibly switched over on the basis of individual wavelengths, are provided in the optical network nodes. This is referred to as dynamic “wavelength routing”.

By automating this “optical channel layer”, i.e. the provision of an automatically switchable optical WDM transmission system (“Automatically Switched Optical Network” (ASON)), in the event of a fault the restoration time and the connection set-up time are considerably reduced. To be regarded as the main tasks of an ASON are the routing and the assignment of a free, i.e. available, WDM transmission channel or a wavelength (“wavelength assignment”), which are considered hereafter as independent tasks which have to be carried out one after the other. Consequently, when setting up a connection, firstly a route through the optical transport network is sought and subsequently an available wavelength is assigned to a connection.

The publication “Control of Lightpaths in an Optical Network”, S. Chaudhuri et al., Optical Interworking Forum 2000, describes a method of wavelength assignment or assignment of a WDM transmission channel in optical transport networks without wavelength conversion. In this case, the same WDM transmission channel is provided for the transmission of the optical WDM signal for the entire connection path from a first optical network node to an Nth optical network node. To determine a WDM transmission channel which is available over the entire connection path, i.e. over a number of connection path sections, a connection vector of the length I is formed in the first optical network node, which initiates the setting-up of the connection, the length I indicating the number of possible (physically present) WDM transmission channels on the first connection path section. In the connection vector, the WDM transmission channels available for the setting-up of the connection on the first connection path section are identified by a logical “1” and the unavailable or already occupied WDM transmission channels are marked by a logical “0”. This connection vector is transmitted along the connection path from optical network node to optical network node to the Nth optical network node or an end node. If, in a connection path section, one of the WDM transmission channels identified as available in the connection vector is already occupied, the entry representing this WDM transmission channel in the connection vector is changed from a logical “1” (available) to a logical “0” (unavailable) in the optical network node preceding the connection path section considered. Consequently, the WDM transmission channels which are available for setting up a connection in all the connection path sections already covered are indicated as available in the connection vector by a logical “1”. Once the connection vector has run through the complete connection path and been received in the end node, the connection vector received includes all the WDM transmission channels which are available for the setting-up of a connection over the connection path sections of the complete connection path. From the available WDM transmission channels, one of the available WDM transmission channels is selected in the end node for the setting-up of the connection and is indicated to the preceding optical network nodes of the connection path. A disadvantage of such a method is that it can be implemented only to a restricted extent in optical transport networks in which some of the optical network nodes have wavelength converters.

An object of the present invention is, therefore, to improve the setting-up of a connection in at least one optical WDM transmission system with a number of switchable optical network nodes, of which at least one has a wavelength converter.

### SUMMARY OF THE INVENTION

A key advantage of the method according to the present invention is that, in the at least one optical network node having a wavelength converter, a further connection vector is formed for identifying available WDM transmission channels on the following connection path section and is transmitted over the at least one optical WDM transmission system. In a particularly advantageous way, the wavelengths available for the setting-up of a connection on the following connection path section on the basis of the wavelength converter provided in the optical network node are identified in a further connection vector, which is transmitted over the optical WDM transmission system to the end node. As a result, in a particularly advantageous way, the setting-up of a continuous connection from a first end node (source) to a second end node (sink) along the connection path is made possible even in the case of an optical network node having a wavelength converter. This results in improved utilization of the wavelengths available on the individual connection path sections and a considerable improvement in the efficiency of the routing on account of the increased flexibility in the selection of the wavelengths available on the individual connection path sections.

The optical WDM transmission channels available within the individual connection path sections for the setting-up of a connection in the optical WDM transmission system are advantageously indicated by the first connection vector and the further connection vector. In this case, in a particularly advantageous way, an available optical WDM transmission channel is indicated, for example, by the entry of a logical “1” and an already occupied optical WDM transmission channel is indicated by the entry of a logical “0” in the connection vector.

A further advantage of the method according to the present invention is that the optical WDM transmission channels marked as available in the first connection vector and the further connection vector by the preceding optical network node are checked by each optical network node for their availability with regard to the following connection path section and that, in the event of unavailability of the optical WDM transmission channels marked as available in the first connection vector and the further connection vector, these channels are marked as unavailable in the first connection vector and the further connection vector. As a result, according to the present invention, only the WDM transmission channels already identified as available are checked for their availability on the following connection path section, thereby achieving a relief in the dynamic loading of the routing hardware within the optical network node.

In an alternative embodiment of the method according to the present invention, the first connection vector is advantageously stored in at least the first optical network node having a wavelength converter. The storing, according to the present invention, of the first connection vector in the optical network node having a wavelength converter has the effect of relieving the dynamic load on the WDM transmission system by dispensing with the additional transmission of the first connection vector to the last network node or end node of the connection path.

Furthermore, according to the present invention, a number of WDM transmission channels are combined to form a WDM channel group and the setting-up of a connection is carried out for a WDM channel group. The combination according to the present invention of a number of WDM transmission channels to form a WDM channel group has the effect that the reservation of the WDM transmission channels selected for the setting-up of a connection, required when setting up a connection, is restricted to the WDM channel group. As such, further available WDM transmission channels, not assigned to the WDM channel group, cannot be reserved for the setting-up of the connection being considered and are consequently available for the setting-up of additional connections over the individual connection path sections.

Additional features and advantages of the present invention are described in, and will be apparent from, the following Detailed Description of the Invention and the Figures.

### BRIEF DESCRIPTION OF THE FIGURES

FIG. 1 shows, by way of example, the method according to the present invention of setting up a connection in an optical WDM transmission system.

FIG. 2 shows, by way of example, an alternative implementation of the method according to the present invention of setting up a connection.

### DETAILED DESCRIPTION OF THE INVENTION

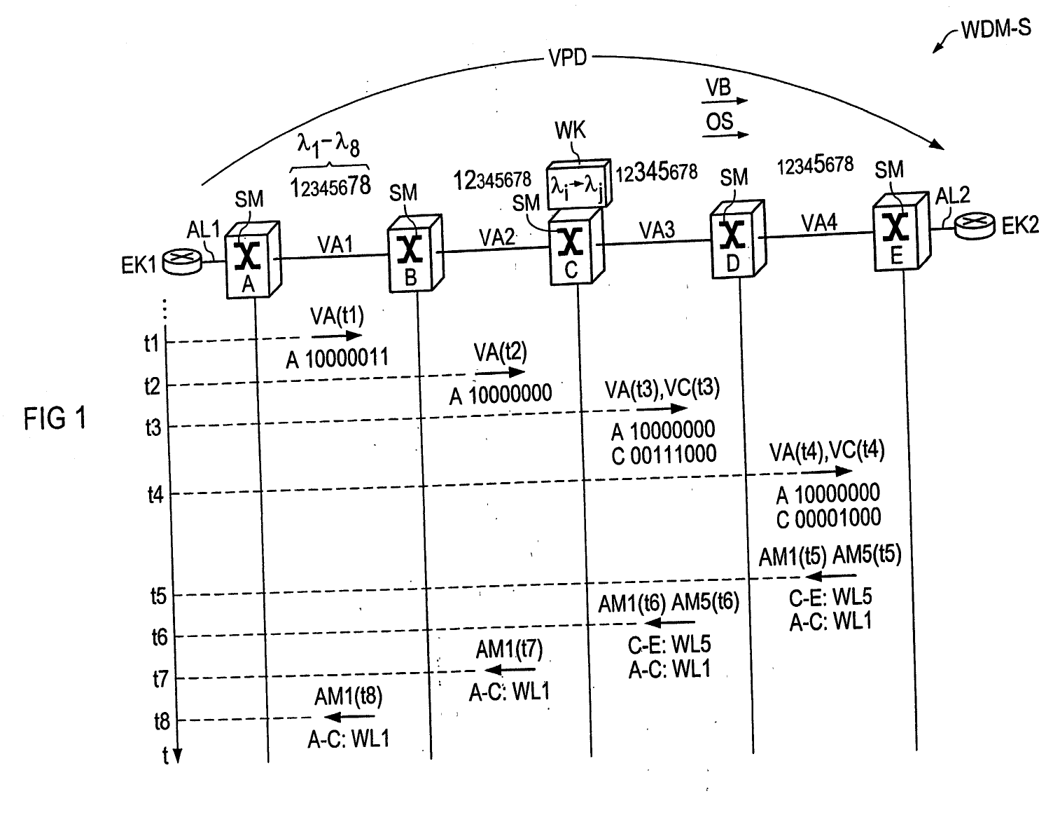

Schematically represented in a block diagram in FIG. 1, by way of example, is an optical WDM transmission system WDM-S, which has a first end node EK1, a first optical network node A, a second optical network node B, a third optical network node C, a fourth optical network node D, a fifth optical network node E and a second end node EK2. The first to fifth optical network nodes A to E have, in each case, an optical switching matrix SM, with a wavelength converter WK being additionally provided in the third optical network node C. The first end node EK1 is connected to the first optical network node A via a first connection line AL1. Furthermore, the first optical network node A is connected via a first optical connection path section VA1 to the second optical network node B, which is, in turn, connected via a second optical connection path section to the third optical network node C, having a wavelength converter WK. The third optical network node C is connected via a third optical connection path section VA3 to the fourth optical network node D, which is connected via a fourth optical connection path section VA4 to the fifth and last optical network node E. The second end node EK2 is linked to the fifth optical network node E via a second optical connection line AL2. For the transmission of, for example, an optical WDM signal OS from the first optical end node EK1 via the first to fifth optical network nodes A to E to the second optical end node EK2, eight WDM transmission channels λ1-λ8 are physically available on each of the five optical connection path sections VA1 to VA4, it being possible for the physically available optical WDM transmission channels λ1 to λ8 to be occupied differently from connection path section to connection path section. In the exemplary embodiment represented in FIG. 1, on the first optical connection path section VA1, for example, the first, seventh and eighth WDM transmission channels λ1, λ7, λ8 are available and the second, third, fourth, fifth and sixth WDM transmission channels λ2-λ6 are already occupied. In a way analogous to this, on the second optical connection path section, the first and second optical WDM transmission channels λ1, λ2 are available and the third to eighth optical WDM transmission channels are already allotted. On the third optical connection path section VA2 also, for example, the third, fourth and fifth optical WDM transmission channels λ3, λ4, λ5 are available for the setting-up of a connection, but the first, second and sixth to eighth optical WDM transmission channels λ1, λ2, λ6 to λ8 already have been assigned to further optical connections. Finally, on the fourth optical connection path section VA4, the fifth optical WDM transmission channel λ5 is available and the remaining, i.e. 1st to 4th and 6th to 8th, optical WDM transmission channels λ1 to λ4, λ6 to λ8 are already occupied.

For the setting-up of a connection VB over the entire connection path VPD, a first connection vector VA, which indicates the WDM transmission channels λ1, λ7, λ8 available on the first connection path section VA1, is formed in the first optical network node A, to which the first end node EK1 is connected via the first connection line AL1. The first connection vector VA is produced at a first point in time t1 in the first optical network node A and has, for example, in the exemplary embodiment considered, eight entries, which indicate the availability of the optical WDM transmission channels λ1 to λ8 physically found on the first optical connection path section VA1. In the exemplary embodiment represented, the first connection vector VA has at the first point in time t1 the content (A 10000011), a logical one marking a WDM transmission channel available for the setting-up of a connection and the logical zero marking an already occupied WDM transmission channel. Furthermore, the first connection vector VA(t1) includes a node identification number A, which indicates in which node the first connection vector VA(t1) was formed; in the exemplary embodiment represented, the first optical network node A. The first connection vector VA, formed in the first optical network node A, is transmitted to the second optical network node B and processed there. For this purpose, the optical WDM transmission channels available on the first optical connection path section VA1, which are indicated in the first optical connection vector VA by a logical one, i.e. the first, seventh and eighth WDM transmission channels λ1, λ7, λ8, are checked for their availability on the second optical connection path section VA2. If one of the optical WDM transmission channels λ1, λ7, λ8 identified as available in the first optical connection vector VA is unavailable on the second optical connection path section VA2, the entry of a logical one, indicating the available optical WDM transmission channel λ7, λ8, is changed by the second optical network node B at a second point in time t2 to a logical zero in the first connection vector VA(t2). In the exemplary embodiment considered, for the optical WDM transmission channels available for the setting-up of a connection over the first connection path section VA1 and the second connection path section VA2, this consequently gives the first optical WDM transmission channel λ1; i.e., further connections have already been made over the other WDM transmission channels λ2 to λ8.

On the third connection path section VA3, the first optical WDM transmission channel λ1 is no longer available for the further setting-up of a connection, so that, according to the known prior art, no further setting-up of a connection would be feasible up to the desired second end node EK2 in the exemplary embodiment considered. However, further setting-up of a connection over the third and fourth connection path sections is possible by the method according to the present invention, in that there is the functionality of the wavelength conversion with the aid of the wavelength conversion WK present in the third optical network node C and the production according to the present invention of a second connection vector VC for the use of further available WDM transmission channels λ2 to λ8. For this purpose, a second or further connection vector VC, which contains the optical WDM transmission channels λ1 to λ8 available and physically possible on the following third optical connection path section VA3, is formed in the third optical network node C, having a wavelength converter WK. The second or further connection vector VC is constructed in a way analogous to the first connection vector VA; i.e., the number of WDM transmission channels λ1 to λ8 physically possible on the third connection path section VA3 is indicated by the number of entries of the second connection vector VC.

In the exemplary embodiment represented, the third, fourth and fifth WDM transmission channels λ3, λ4, λ5 are identified by a logical one in the second connection vector VC, whereby their availability for the setting-up of a connection is indicated. The remaining entries of the second connection vector VC are indicated by logical zeros, i.e. the first, second and sixth, seventh and eighth WDM transmission channels ), λ1, λ2, λ6 to λ8 are already occupied. The second connection vector VC is transmitted, for example together with the first connection vector VA, at the third point in time t3 to the fourth optical network node D. Optionally, the present invention provides that a storage of the first connection vector VA(t3) can be carried out in the third optical network node C, having a wavelength converter WK; i.e., the optical network node C initiating the second connection vector VC.

In the exemplary embodiment represented, the second connection vector VC(t3) is transmitted together with the first connection vector VA over the third connection path section VA3 to the fourth optical network node D. In the fourth optical network node D, the third, fourth and fifth optical WDM transmission channels λ3, λ4, λ5, indicated as available in the second connection vector VC(t3), are checked for their availability on the fourth and last connection path section VA4 and, if appropriate, identified as unavailable or occupied. In the exemplary embodiment considered, on the fourth connection path section VA4 only the fifth WDM transmission channel λ5 is available; i.e., the logical one entries indicating the availability of the third and fourth WDM transmission channels λ3, λ4 are replaced in the fourth optical network node D by logical zero entries and, as a result, are indicated as unavailable or occupied in the second connection vector VC(t4) at the fourth point in time t4. The second connection vector VC(t4) revised in this way at the fourth point in time t4 is transmitted over the fourth connection path section VA4 to the fifth optical network node E. In the fifth optical network node E, both the first connection vector VA(t4), if transmitted, and the further connection vector VC(t4) are transmitted over the second connection line AL2 to the second end node EK2.

In the second end node EK2, from the available optical WDM transmission channels λ1, λ5 which are indicated by the first and further connection vectors VA(t4) and VC(t4), WDM transmission channels available for the setting-up of a connection VB are selected for the respective connection path sections VA1 to VA4 and are indicated with the aid of, for example, a first and fifth occupancy message AM1(t5), AM5(t5) at the fifth point in time t5 to the first to fifth optical network nodes A to E, or are transmitted to them. For this purpose, the first and fifth occupancy messages AM1(t5), AM5(t5) are formed in the second end node EK2, or optionally in the fifth optical network node E and, for example, a validity range C-E, A-C is determined for the first and fifth occupancy messages AM1, AM5, respectively, and assigned to the first and fifth occupancy messages AM1, AM5. The first and fifth occupancy messages AM1, AM5 are transmitted from the fifth optical network node E to the fourth optical network node D over the fourth connection path section VA4 in the direction of the first end node EK1. In the fourth optical network node D, the fifth occupancy message AM5 is evaluated and, on the fourth connection path section VA4, the fifth optical WDM transmission channel λ5 is switched through for the setting-up of the connection VB. The first and fifth occupancy messages AM1(t6), AM5(t6) are transmitted from the fourth optical network node D to the third optical network node C over the third connection path section VA3. In the third optical network node C, the fifth occupancy message AM5(t6), having the validity range C to E, is evaluated and, in a way analogous to the fourth connection path section, the fifth WDM transmission channel λ5 is also switched through in the third connection path section VA3. The fifth occupancy message AM5(t6) is stored at the sixth point in time in the third optical network node C for diagnostic purposes, or alternatively is erased after the first connection has been set up. Furthermore, the first occupancy message AM1(t7) is transmitted from the third optical network node C over the second connection path section VA2 to the second optical network node B.

Furthermore, with the aid of the wavelength converter WK in the third optical network node C, a wavelength conversion from the first WDM transmission channel λ1 to the fifth WDM transmission channel λ5 is prepared for the setting-up of the optical connection VB over the entire connection path VPD, i.e. the WDM transmission channel intended for the connection VB considered is changed in the third optical network node C. In the exemplary embodiment represented, consequently, for the first and second connection path sections VA1, VA2 the first WDM transmission channel λ1 is intended for the setting-up of a connection and, after a wavelength conversion in the third optical network node C, the setting-up of the connection VB on the third and fourth connection path sections VA3, VA4 up to the second end node EK2 is carried out over the fifth WDM transmission channel λ5.

The first occupancy message AM1(t7), received in the second optical network node B at the seventh point in time t7, is evaluated in the second optical network node B and the first WDM transmission channel λ1 is prepared for the setting-up of the connection VB on the second connection path section VA2. Subsequently, the first occupancy message AM1(t8), having the validity range A to C, is transmitted at the eighth point in time t8 to the first optical network node A and evaluated there, and also stored or alternatively erased. After the evaluation of the first occupancy message AM1(t7), according to the result of the evaluation, the first WDM transmission channel λ1, established by the first occupancy message AM1(t8), is intended for the setting-up of the connection VB on the first connection path section VA1. Consequently, the first and fifth WDM transmission channels λ1, λ5 are alternately reserved along the complete connection path VPD from the first end node EK1 to the second end node EK2 for the setting-up of the connection VB, over which the transmission of the optical signals OS can be carried out.

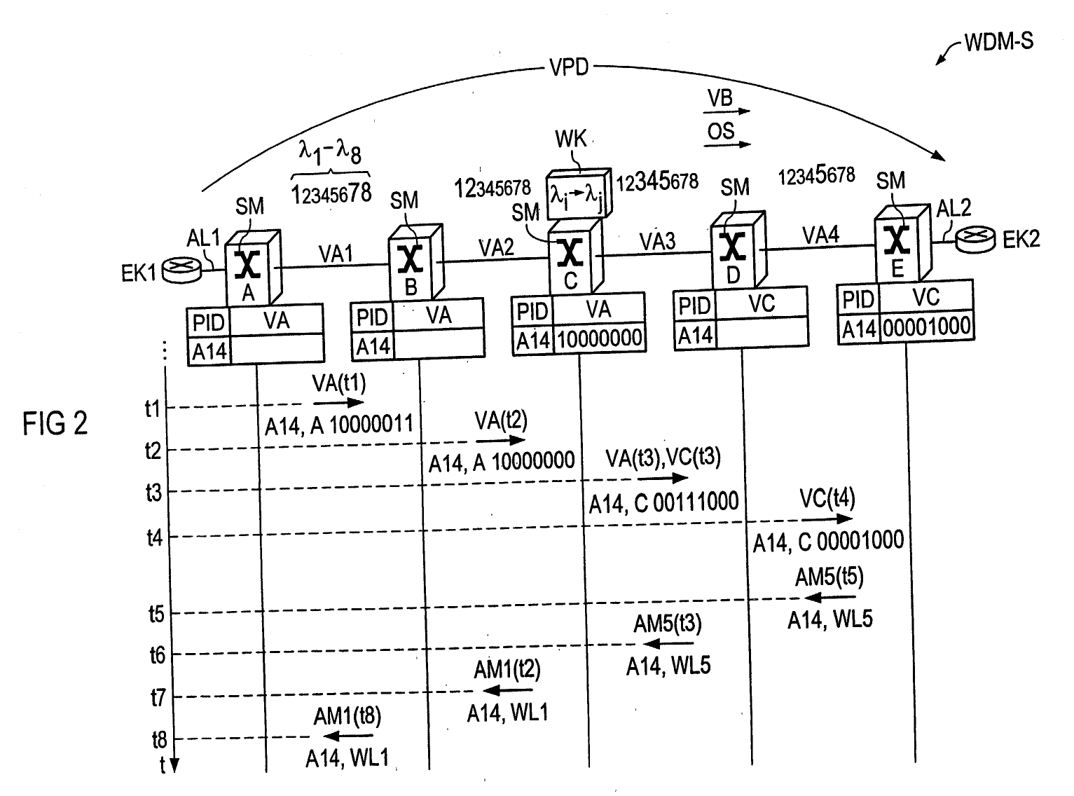

Schematically represented in FIG. 2 is a further embodiment of the method according to the present invention for the setting-up of a connection in an optical WDM transmission system WDM-S, in which a connection path VPD or a connection VB is, in turn, set up from a first end node EK1 via first to fifth optical network nodes A to E to a second end node EK2. In a way analogous to the exemplary embodiment represented in FIG. 1, the first end node EK1 is connected via a first connection line AL1 to the first optical network node A. The first optical network node A is connected via a first optical connection path section VA1 to the second optical network node B which, in turn, is connected via a second connection path section VA2 to the third optical network node C. In a way analogous to FIG. 1, the third optical network node C has a wavelength converter WK. The third optical network node C is also connected via a third connection path section VA3 to the fourth optical network node D, which is linked via a fourth connection path section VA4 to the fifth optical network node. The second end node EK2 is connected via a second connection line AL2 to the fifth optical network node E. In the case of the exemplary embodiment considered in FIG. 2 also, the first to fifth optical network nodes A to E have, in each case, a switching matrix SM for the switching of connections VB.

On the first to fourth connection path sections VA1 to VA4, eight different physically possible wavelengths or WDM transmission channels λ1 to λ8 are available for the setting-up of a connection. In the case of the exemplary embodiment represented in FIG. 2, for example, the first, seventh and eighth WDM transmission channels are available on the first connection path section VA1, the first and second channels are available on the second connection path section VA2, the third, fourth and fifth channels are available on the third connection path section VA3 and the fifth channel is available on the fourth connection path section VA4. For the setting-up of a connection VB over the entire connection path VPD, a first connection vector VA(t1), which indicates the WDM transmission channels λ1, λ7, λ8 available on the first connection path section VA1, is formed in a way analogous to the first exemplary embodiment in the first optical network node A at the first point in time t1. In addition to the node identification number A, in the case of the exemplary embodiment represented in FIG. 2, a path identification number 14 is assigned to the first connection vector VA(t1) at the first point in time t1, providing unique numbering for the connection VB to be set up. The indication of the available or unavailable WDM transmission channels λ1 to λ8 within the first connection vector VA takes place in a way analogous to the exemplary embodiment represented in FIG. 1. The determination of the WDM transmission channels λ1 to λ8 available in the individual connection path sections VA1 to VA4 is performed in a way analogous to the description of the first exemplary embodiment. By contrast with the exemplary embodiment represented in FIG. 1, however, in the case of the further exemplary embodiment in FIG. 2, the first connection vector VA is stored in the third optical network node C, having a wavelength converter WK, and consequently the transmission along the entire connection path VPD up to the second end node EK2 is advantageously eliminated.

The second connection vector VC, produced in the third optical network node C, is transmitted over the third connection path section VA3 to the fourth optical network node D. In this case, the second connection vector VC respectively has the node identification number C of the third optical network node C and, by analogy with the first connection vector VA, the path identification number 14. In a way analogous to the representation in FIG. 1, the second connection vector VC is revised at the third point in time t3 in the fourth optical network node D in such a way that the first, fourth and fifth optical WDM transmission channels λ3, λ4, λ5 identified as available in the second or further connection vector VC(t3) are checked for their availability on the fourth connection path section VA4 and, if appropriate, identified as unavailable or occupied. It is also the case in the alternative implementation in FIG. 2 that only the fifth WDM transmission channel λ5 is available for the setting-up of a connection on the fourth connection path section VA4, i.e. the logical “one” entries in the second connection vector VC(t4), indicating the availability of the third and fourth WDM transmission channels λ3, λ4, are replaced in the fourth optical network D by logical “zero entries”. Consequently, only the fifth WDM transmission channel λ5 is still available for the setting-up of a connection on the fourth connection path section VA4. The second or farther connection vector VC revised in this way is transmitted at the fourth point in time t4 over the fourth connection path section VA4 to the fifth optical network node E. In the fifth optical network node E, the second connection vector VC is transmitted over the second connection line AL2 to the second end node EK2.

By contrast with the first exemplary embodiment, in the case of the exemplary embodiment represented in FIG. 2, in the second end node EK2 only the second connection vector VC(t4) is evaluated and one of the WDM transmission channels identified as available by the second connection vector VC(t4) is selected for the setting-up of the connection over the third connection path section and the fourth connection path section VA3, VA4. In the selection of the WDM transmission channel λ1 to λ8 available for the setting-up of the connection, various selection criteria may be implemented, for example the individual available WDM channels may be used according to their hierarchical sequence or, to avoid one-sided loads, the statistical occupancy frequency of the individual WDM transmission channels λ1 to λ8 maybe taken into consideration in the selection.

In the second end node EK2, in a way analogous to FIG. 1, an occupancy message AM5(t5), which indicates the fifth WDM transmission channel λ5 selected for the setting-up of the connection VB, is produced at the fifth point in time t5. By contrast with FIG. 1, in the case of the embodiment of the method according to the present invention represented in FIG. 2, only one occupancy message AM5(t5) is initially transmitted from the second end node EK2 to the fifth optical network node E and from the latter over the fourth connection path section VA4 to the fourth optical network node D. The fifth occupancy message AM5(t5), received at the fifth point in time t5 in the fourth optical network node D, is evaluated there and, according to the path identification number 14 contained in the occupancy message AM5(t5) and the node identification number A and also the selected fifth WDM transmission channel λ5, the switching matrix SM provided in the fourth optical network node D is set. Consequently, the fifth WDM transmission channel λ5 is set up for the setting-up of the connection VB on the fourth connection path section VA4.

Subsequently, the fifth occupancy message AM5 is transmitted at the sixth point in time t6 over the third connection path section VA3 to the third optical network node C, having a wavelength converter WK.

In the third optical network node C, the end of the validity range C to E of the fifth occupancy message AM5 is reached and the content of the fifth occupancy message AM5 is finally evaluated. According to the result of the evaluation of the fifth occupancy message AM5, the switching matrix SM, to be switched in the third optical network node C, is set for the third connection path section VA3 in such a way that the fifth WDM transmission channel λ5 is available for the setting-up of the connection on the third connection path section VA3. Following this, according to the node identification number A determined from the fifth occupancy message AM5 and the path identification number 14 from the memory of the third optical network node C, the associated first connection vector VA is read out and its content is evaluated for the further setting-up of the connection. For this purpose, the WDM transmission channel available on the first and second connection path sections VA1, VA2 is determined from the logical “one” entries present in the first connection vector and, on the basis of the WDM transmission channel selected for the further setting-up of the connection, a corresponding first occupancy message AM1(t7) is produced at the seventh point in time t7. The first occupancy message AM1(t7) includes, in turn, the same node identification number A and the same path identification number 14 and also the first WDM transmission channel λ1, established for the setting-up of the connection over the first and second connection path sections VA1, VA2. This first occupancy message AM1(t7) is transmitted from the third optical network node C over the second connection path section VA2 to the second optical network node B.

In the second optical network node B, in a way analogous to the embodiment of the method according to the present invention represented in FIG. 1, only the first connection vector VA(t7) is evaluated, and the switching matrix SM located in the second network node B is correspondingly set. Following this, the first occupancy message AM1(t8) is transmitted at the eighth point in time t8 over the first connection path section VA1 to the first optical network node A. In the first optical network node A, the switching matrix SM present in the first optical network node A is prepared in accordance with the received first occupancy message AM1(t8) for switching through the connection VB proceeding from the first end node EK1 over the first connection line AL1 and over the first connection path section; i.e., the first WDM transmission channel λ1 is switched through on the first connection path section VA1 for the setting-up of the connection. Consequently, the complete connection path VPD is switched through from the first end node EK1 to the second end node EK2, so that a transmission of optical signals OS can be carried out over the switched optical connection VB.

It is true for both the embodiment of the method according to the present invention represented in FIG. 1 and the embodiment represented in FIG. 2 that, from the point in time of the sending of the first connection vector VA to the reception of the first occupancy message AM1 in the first optical network node A, a reservation of the WDM transmission channels λ1, λ2 identified as available in the first and second connection vectors VA, VC is carried out within the network nodes A to E decisive for the setting-up of the connection. To avoid a large number of available WDM transmission channels λ1 to λ8 being blocked in this case by several setups of connections taking place at one and the same time, a combination of a number of WDM transmission channels λ1 to λ8 to form individual transmission channel groups can be achieved according to the present invention. In this case, a reservation of the respective transmission channel group is sufficient, so that the further available WDM transmission channels or transmission channel groups of a connection path section VA1 to VA5 can be freely used or allotted for the setting-up of further connections.

If it is necessary to set up a number of connections over virtually the same connection path VPD over the individual available WDM transmission channels λ1 to λ8, from a first end node to a second end node EK1 to EK2, this is possible according to the present invention with the aid of a single pair of connection vectors or a single first connection vector VA and a single second connection vector VC; i.e., according to the present invention a number of connections VB can be carried out over the same connection path VPD by using a first connection vector VA and a further connection vector VC in the way according to the present invention. However, when setting up a number of connections VB by the method according to the present invention with the aid of a first connection vector VA and a further connection vector VC, information concerning the number of connections VB to be set up must be included in the first connection vector VA or the further connection vector VC; i.e., the number of WDM transmission channels available per connection path section VA1 to VA4 for the setting-up of a number of connections is entered in the form of binary information in the first or second connection vector. As a result, the amount of signaling required for the setting-up of a number of connections VB is significantly reduced, whereby the optical WDM transmission system WDM-S is relieved of dynamic loading.

The present invention is not restricted in any way to the provision of one further connection vector VC; instead, for the setting-up of a connection or a multiplicity of connections within a WDM transmission system WDM-S with a number of optical network nodes A to E, having a number of wavelength converters WK, according to the present invention a number of connection vectors having different validity ranges are provided.

Indeed, although the present invention has been described with reference to specific embodiments, those of skill in the art will recognize that changes may be made thereto without departing from the spirit and scope of the invention as set forth in the hereafter appended claims.

1. A method of setting up a connection in at least one optical WDM transmission system with a plurality of switchable optical network nodes, at least one of the plurality of switchable optical network nodes having a wavelength converter, wherein for setting up a connection from a first optical network node over at least one connection path section to an Nth optical network node, the method comprises the steps of:
forming a first connection vector for identifying WDM transmission channels available on a following connection path section;
transmitting the first connection vector over the at least one optical WDM transmission system;
forming a further connection vector, in the at least one optical network node having a wavelength converter, for identifying the available WDM transmission channels on the following connection path section; and
transmitting the further connection vector over the at least one optical WDM transmission system.

2. A method of setting up a connection in at least one optical WDM transmission system as claimed in claim 1, the method further comprising the step of marking the available WDM transmission channels by the first connection vector and the further connection vector.

3. A method of setting up a connection in at least one optical WDM transmission system as claimed in claim 1, the method further comprising the steps of:
checking the available optical WDM transmission channels by each of the plurality of optical network nodes for availability with regard to a following connection path section; and
marking, if the checking of availability results in unavailability of the plurality of optical WDM transmission channels marked as available in the first connection vector and the further connection vector, the unavailable channels as unavailable in the first connection vector and the further connection vector.

4. A method of setting up a connection in at least one optical WDM transmission system as claimed in claim 1, the method further comprising the step of indicating a dimension of the first connection vector and the further connection vector by a number of optical WDM transmission channels provided in the optical WDM transmission system.

5. A method of setting up a connection in at least one optical WDM transmission system as claimed in claim 1, the method further comprising the steps of:
selecting at least one of the available WDM transmission channels, available for the setting up of a connection and marked in the connection vector, by at least one of the N^{th} optical network node and at least one optical network node having a wavelength converter; and
indicating the at least one of the available WDM transmission channels to preceding optical network nodes.

6. A method of setting up a connection in at least one optical WDM transmission system as claimed in claim 1, the method further comprising the steps of:
selecting at least one of the available WDM transmission channels, available for the setting up of a connection and marked in the further connection vector, by at least one of the N^{th} optical network node and at least one further optical network node having a wavelength converter; and
indicating the at least one of the available WDM transmission channels to the preceding optical network nodes.

7. A method of setting up a connection in at least one optical WDM transmission system as claimed in claim 1, the method further comprising the step of storing the first connection vector in at least the first optical network node having a wavelength converter.

8. A method of setting up a connection in at least one optical WDM transmission system as claimed in claim 1, the method further comprising the step of combining a plurality of WDM transmission channels to form a WDM channel group, wherein the setting up of a connection is carried out for a WDM channel group.

9. A method of setting up a connection in at least one optical WDM transmission system as claimed in claim 8, the method further comprising the steps of:
assigning, when setting up a connection for a WDM channel group, information indicating a number of connections to be set up to the connection vectors; and
including the information indicating the number of connections to be set up in the transmission.

10. A method of setting up a connection in at least one optical WDM transmission system as claimed in claim 5, the method further comprising the step of indicating the optical WDM transmission channels selected, for the setting up of the connection for each connection path section, to the preceding optical network nodes by at least one occupancy message.

11. A method of setting up a connection in at least one optical WDM transmission system as claimed in claim 10, the method further comprising the step of assigning the at least one occupancy message a validity range which specifies the connection path sections for which the occupancy message is valid.
